(19) United States
(12) Patent Application Publication
(10) Pub. No.: US 2002/0014539 A1
(43) Pub. Date: Feb. 7, 2002

(54) Irrigation system for controlling irrigation in response to changing environmental conditions

(76) Inventors: David D. Pagano, Orange, CA (US); Michael B. Marian, Petaluma, CA (US)

Correspondence Address: Horace H. Ng, TOWNSEND and TOWNSEND and CREW LLP, Two Embarcadero Center, 8th Floor, San Francisco, CA, 94111-3834, US

(21) Appl. No.: 09/745,175

(22) Filed: Dec. 19, 2000

Related U.S. Application Data
(63) Continuation of application No. 09/436,684, filed on Nov. 8, 1999, now abandoned.

(51) Int. Cl. B05B 12/08

(52) U.S. Cl. 239/1; 239/63; 239/69

(57) ABSTRACT

An irrigation system having an irrigation controller, a means for detecting changes in environmental conditions, a valve, and a sprinkler connected to a irrigation supply. The controller controls the operation of the valve and the sprinkler in accordance with an irrigation schedule to selectively irrigate a specified number of vegetation areas. The irrigation schedule is adjusted automatically in response to changing environmental conditions. The irrigation schedule is created based on a number of input parameters including the number of cycles to be executed each day, the duration of each cycle, and the number of days in the irrigation period. After receiving the appropriate input parameters, the controller then automatically determines the days within the irrigation period on which irrigation should occur.

### CROSS REFERENCE TO RELATED APPLICATION(S)

This application is a continuation of and claims the benefit of prior U.S. patent application Ser. No. 09/436,684, filed on Nov. 8, 1999.

### BACKGROUND OF THE INVENTION

The present invention relates generally to irrigation systems, and more specifically to an irrigation system that offers improved irrigation in response to changing environmental conditions.

It is commonly known in the agricultural and landscape industry to use irrigation controllers to control irrigation systems. In irrigation systems, there may be many sprinklers and many valves. Large systems employ many controllers in many locations. Traditionally, irrigation managers, were left to their own inclinations and judgment when it came to developing irrigation schedules for their vegetation areas. In general, these irrigation schedules were limited to only specifying the length of time of each irrigation cycle and the number of irrigation cycles to be executed in a day and the day to water.

It is known to provide controllers with radio receivers to permit an operator to remotely adjust the initial irrigation schedule of any single controller, or group of controllers. However, simply changing the duration of a cycle or the number of cycles to be executed in a day may produce ineffective irrigation schedules. In some instances, once a cycle becomes too short, the amount of water falling on the plant to be irrigated may be wholly ineffective. For some soils and conditions, the first water impulses reaching the soil may run-off or pool and evaporate and not penetrate to the root structures. In other cases, a shortened cycle may not be sufficient, in the case of rotary sprinklers, to advance the sprinkler 360 degrees.

Furthermore, most irrigation schedules are rarely changed once they are established nor are they sensitive to any changing environmental conditions. The stagnant nature of these irrigation schedules, therefore, often results in over-or under-irrigation of the vegetation areas as weather and environmental conditions changes. Therefore, there is a need to provide an irrigation system which is responsive to changing environmental conditions and capable of providing the appropriate amount of irrigation at the proper frequency.

Moreover, owing to many factors, including the complexity of the typical controller, the broad geographic distribution of the various locations, and the relatively low unit cost of water, the initial schedule is infrequently, if ever, adjusted as appropriate. For example, during rainstorms or particularly wet periods, some irrigators do not bother to decrease the amount of water applied at the vegetation locations, resulting in a substantial waste of water.

While water was perhaps once viewed as an unlimited natural resource, years of abuse and waste have now threatened the sanctity of many water supplies. As the public's awareness of the issues surrounding commercial irrigation and water conservation increases, the irrigators are now under increasing pressure to implement effective programs and controllers to monitor the proper usage of their water supplies. Hence, there is a strong need to provide an irrigation system which is capable of minimizing the waste of water.

### SUMMARY OF THE INVENTION

It is an object of the present invention to provide an improved irrigation system having an irrigation controller that operates in accordance with an irrigation schedule.

It is another object of the present invention to provide an improved irrigation system having an irrigation schedule which automatically determines the days within an irrigation period on which irrigation should occur.

It is a further object of the present invention to provide an improved irrigation system having an irrigation schedule which can be modified automatically or manually in response to changing environmental conditions.

It is yet another object of the present invention to provide an improved irrigation system capable of providing water for irrigation at the proper irrigation frequency.

It is yet a further object of the present invention to provide an improved irrigation system capable of minimizing waste of irrigation water.

The present invention provides for an irrigation controller which is capable of establishing an irrigation schedule for a vegetation area over an irrigation period. The present system first determines an appropriate irrigation cycle time and a number of irrigation cycles to be used for an irrigation day of the irrigation period. It then identifies one or more of the irrigation days during the irrigation period to maintain a quantity of water within the root zone of the vegetation area in accordance with a predetermined water profile.

Reference to the remaining portions of the specification, including the drawing and claims, will realize other features and advantages of the present invention. Further features and advantages of the present invention, as well as the structure and operation of various embodiments of the present invention, are described in detail below with respect to accompanying drawings. In the drawings, like reference numbers indicate identical or functionally similar elements.

### BRIEF DESCRIPTION OF THE DRAWINGS

FIG. 1 is a block schematic view of a preferred embodiment of the present irrigation system.

FIG. 2 is a table showing the month-by-month plant factors for warm season and cool season turf grass respectively.

### DESCRIPTION OF THE SPECIFIC EMBODIMENTS

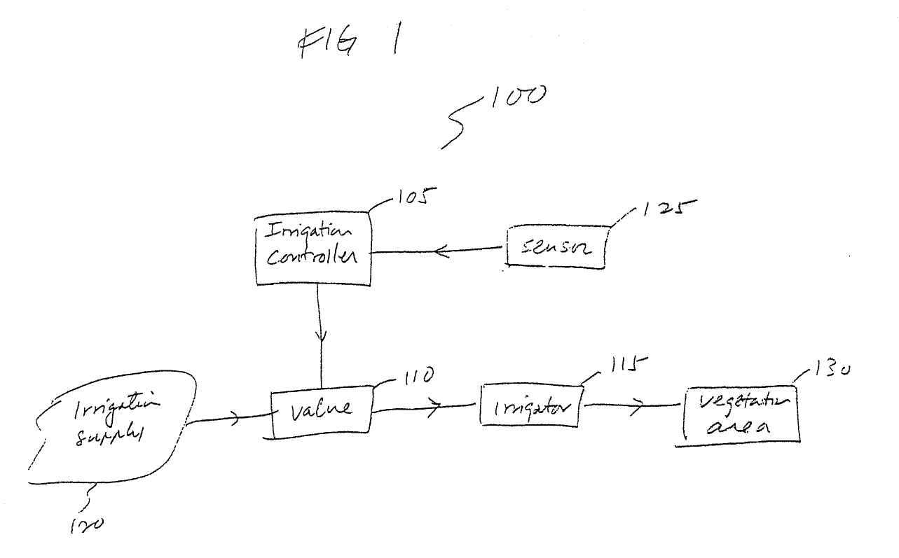

A new and improved irrigation system embodying the principles and concepts of the present invention is shown generally in FIG. 1. FIG. 1 is a block schematic view of an irrigation system 100 including an irrigation controller 105, a sensor 125 for detecting changes in environmental conditions, a valve 110, and an irrigator 115 connected to a irrigation supply 120. The controller 105 controls the operation of the valve 110 and the irrigator 115 in accordance with an irrigation schedule to selectively irrigate a specified number of vegetation areas. The irrigation schedule is adjusted automatically in response to changing environmental conditions. The sensor 125 is capable of detecting changes in environmental conditions automatically or manually via an user operable interface. The sensor 125 may include simple devices such as a pager system disclosed in U.S. Pat. No. 4,962,522 as well as more sophisticated equipment including equipment for receiving and transmitting evapotranspiration (ET) data such as the broadcast system disclosed in U.S. Pat. No. 5,208,855. The irrigation system 100 is a scalable system having the capability to accommodate and control additional valves 110, irrigators 115 and irrigation supplies 120.

The irrigation schedule is created based on a number of input parameters including the number of cycles, X, to be executed each day, the duration of each cycle, Z (in minutes), and the number of days, Y, in the irrigation period. An irrigation period is defined as the length of time after which the irrigation schedule will repeat itself. This period can be based on days, weeks, months or years or some other predetermined period of time.

A user has the option of specifying an individual value for each of the input parameters or choosing a predetermined set of parameters for a particular plant type. After receiving the appropriate input parameters, the controller 105 then automatically determines the days within the irrigation period on which irrigation should occur to insure that the plants being irrigated receive only the proper and adequate amount of water thereby minimizing the waste of any excess water. Controller 105 then operates the valve 110 according to the irrigation schedule to cause the irrigator 115 to appropriately and selectively irrigate certain specified vegetation areas 130 at the scheduled times.

ET is a term commonly used to describe and quantify the amount of water consumed by plants. The “E” represents evaporation of water from the soil and plant surfaces. The “T” stands for transpiration of water as a vapor through the plant's leaves to the air. The rate at which water is consumed by the plant is the ET rate. This rate is usually expressed in inches per day. Obviously, any water applied in excess of the ET rate is simply wasted due to the plant's inability to consume such water. Such excess water merely runs off the soil surface or percolates to a location below the plant's root zone area where the water can no longer be effectively reached by the plant. Hence, it is a goal of the present irrigation system to closely track the rate of irrigation with the ET rate so as to ensure efficient utilization of the water supply by creating and using a water profile.

As is commonly known in the industry, seasonal weather changes affect the ET rate for each plant species. These seasonal changes roughly correspond to the total daylight hours. More specifically, ET rates are lower in the winter when the days are relatively shorter and become increasingly higher in the spring as the days become longer. The ET rates cyclically peak in the summer when the daylight hours are at their maximum and then begin to gradually decrease as the fall approaches.

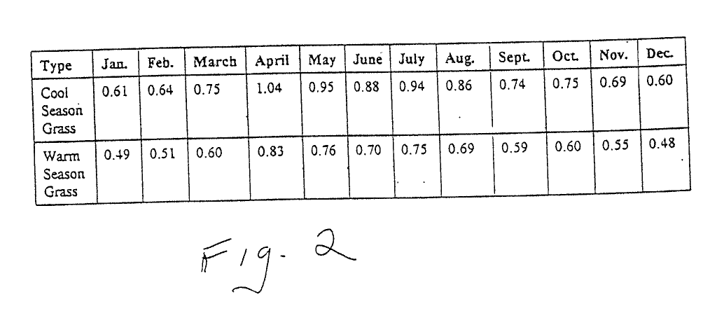

The plant factor, also known as crop coefficient, is a factor that, when multiplied by the ET rate, provides a general estimate on the amount of water required by a particular plant species each day. Each species has its own particular plant factor, for example, the average plant factor for low-water-consuming plants is found to be 0.3, for average-water-consuming plants is 0.5, and for high-water-consuming plants is 0.8. Furthermore, a particular plant species may have a different plant factor for each month of the year. FIG. 2 is a table showing the month-by-month plant factors for warm season and cool season turf grass respectively. The annual average plant factor for warm season turf grass (such as Bermuda grass) is 0.6 and that for cool season turf grass (such as Kentucky bluegrass) is 0.8. Information and data concerning several thousand plant factors for various plant species have been experimentally determined and compiled. Such information and data can be easily obtained from simple measurement and experimentation from sources such as those listed in the Appendix attached hereto.

By using the available ET rates and plant factors, input parameters such as the number of cycles, X, to be executed per day and the duration of each cycle, Z, may be adjusted accordingly. Techniques and methods for adjusting X and Z are commonly known in the industry. However, unlike the irrigation systems currently available on the market today, the present system not only adjusts the number of cycles to be executed per day and the duration of each cycle, it also calculates the days of the irrigation period on which irrigation should occur. As will be explained shortly, the inclusion of this last feature is critical to better irrigation and water conservation and to producing healthier plants.

The frequency of irrigation is an important but often ignored issue. The primary goal of developing an irrigation schedule is to add the appropriate amount of water at the proper time to the vegetation area benefiting the plants located therein. However, adding the right total amount of water for an irrigation period at the wrong intervals or frequency does not accomplish this goal. In fact, studies have shown that irrigating at the wrong intervals or frequency can be detrimental to the health of the plant, and can also result in a substantial waste of water.

In determining the proper irrigation frequency, a number of factors have to be considered, including (1) the water consumption need for a particular plant species for the desired irrigation period, (2) the plant species' root depth, (3) the amount of water available to the plant that is retained in the soil within the plant's root zone, also known as available water, (4) the ability to irrigate the plant when water is needed, and (5) the maximum threshold amount of water allowed to be depleted from the root zone before irrigation is needed; this amount is often fifty percent (50%) of the available water.

The root zone of a plant species is the approximate volume of soil generally reachable by the roots of the plant. Based on this definition, only water or moisture which is available within its root zone, also known as the soil reservoir, can be consumed by the plant. Therefore, the moisture holding capacity of the root zone is a critical parameter in determining the proper irrigation frequency. The moisture holding capacity varies depending on the type of soil used in the vegetation area. Data relating to the moisture holding capacity of the root zone of various plant species can be obtained from sources such as those listed in the Appendix.

The vertical depth of the root zone as measured from the soil surface is the root depth. The root depth of a plant species can be altered by irrigation frequency and soil type.

Even when the appropriate amount of water for a given irrigation period is calculated correctly by the user, if the water is not applied to the plant at the appropriate frequency, problems will arise. For example, given a fixed amount of water for a certain irrigation period, if the environmental factors dictate that irrigation frequency should be four days per week but the user instead selects seven days per week, then the amount of water applied in each of the seven days will not be sufficient to fully maximize the capacity of the soil reservoir of the root zone. Such deficiency occurs because the same amount of water is now distributed over seven days instead of the optimal four days. When only the top portion of the root zone is irrigated, the lower roots of the plant will become inactive. As a result, these lower roots tend to deteriorate rapidly after pruning and mowing, thereby reducing the depth of the root zone which, in turn, impairs the ability of the plant to absorb an adequate amount of water.

Consequently, when the weather becomes hotter and drier in the summer months, the plants with shortened root zones may lose water to transpiration at a rate that is faster than the rate at which they can replenish the water through their shortened root zones. If left unchecked, this net loss of water will eventually cause the plant to wither and die of dehydration. In order to remedy this situation, the irrigation water manager will often hastily modify the irrigation schedule to impose the additions of an usually excessive amount of water in an effort to save the dying plant. These sudden additions of water, however, does not provide any relief because the excessive water will merely pass straight through the plant's root zone (now shortened due to the incorrect irrigation schedule) rendering the water unusable. The plant may survive with these shorter roots, but it is more likely to be susceptible to diseases and other infections and will commonly go off color. In any event, the sudden deluge of water will only result in water being wasted. Frequently, huge amounts of water are added within a short period of time in a desperate attempt to salvage or restore the vegetation area. Unfortunately, due to the plant's finite and limited absorption rate, most of this water only ends up at some location unreachable by the plant.

Similarly, consider the situation in which the irrigation water manager selects a three-day irrigation schedule when the environmental factors dictate that the irrigation frequency should be six days per week. The same amount of water is distributed over three days as opposed to six. During each of the three irrigation days, more water is applied than can be held by the plant's soil moisture reservoir. This additional water infiltrates beyond the plant's root zone where it cannot be reached by the plant. As a result, on the days when there is no irrigation, there is a moisture deficiency within the plant's root zone and the plant is likely to develop the same symptoms, such as shortened roots, as are commonly seen when irrigation is conducted too frequently. This lack of water, if not remedied in a timely manner, will also cause the plant to die eventually. Again, the most common approach used by irrigation water managers in an attempt to provide immediate relief is to water the plant arbitrarily with an excessive amount of water without regard to the irrigation frequency. For reasons already discussed above, this approach mostly results in a substantial waste of water while providing little benefit.

The present invention first utilizes various traditionally recognized methods as are commonly known in the art to determine the appropriate irrigation cycle time and the number of cycles to be executed each day. Details concerning the theory and practical applications of such methods can be found in a number of authoritative literature such as those listed in the Appendix. Having determined the foregoing two parameters, the present system then automatically establishes an irrigation schedule to distribute the irrigation water at the proper irrigation frequency.

In establishing the irrigation schedule, the system creates a water profile for each plant species to be irrigated by calculating the approximate total amount of water needed for a specified irrigation period. Using data relating to the factors identified above, such as root zone, available water, and allowable depletion, the system then identifies the appropriate days within the irrigation period on which irrigation should occur.

The present system further provides a self-adjusting capability to accordingly modify the irrigation schedule in response to changing environmental conditions. For example, as the weather becomes hotter and the ET rates increase, the system detecting such changing conditions automatically adjusts the irrigation schedule to provide for adequate irrigation. More specifically, the system continually estimates the amount of available water within the plant's root zone. If the amount of available water falls or is expected to fall below a predetermined threshold indicating an impending shortage of water, the system then compensates accordingly by adding an appropriate number of irrigation day(s) onto the irrigation schedule, depending on the severity of the need. Conversely, as the weather becomes cooler and the ET rates start to decrease causing the amount of available water to exceed a predetermined threshold, the system similarly adjusts the irrigation schedule by deleting or removing certain irrigation day(s), thereby preventing unnecessary irrigation and loss of water.

In other cases, environmental factors such as low humidity, high ET rates and low water holding capacity of the soil may not only require irrigation seven days a week, but may also mandate that additional irrigation should occur during the same day. This condition generally arises when the available water within the plant's root zone reaches the fifty percent (50%) allowable depletion level before a day is complete. In that situation, the plant's soil moisture reservoir is not large enough to hold the total amount of water needed for one day. Adding the plant's total daily water need all at once or within relatively short intervals would only saturate the soil and overfill the capacity of its soil moisture reservoir causing the water to run off or infiltrate to a region below the plant's root zone. In either case, this water would not be available to the plant even though the total day's water requirement was provided by the irrigation controller.

The present system recognizes this condition and causes an additional irrigation cycle or cycles to occur at the appropriate intervals so as to maintain the capacity of the plant's soil moisture reservoir at the desired level. More specifically, as the capacity of the soil moisture reservoir begins to decrease due a higher ET rate or other environmental factors causing the 50% allowable depletion level to be reached for the second or perhaps the third time during the same day, the present system activates the irrigation controller to set additional start times for extra irrigation cycles during the same day, thereby providing sufficient water to prevent the depletion of soil moisture from exceeding a predetermined threshold such as 50% of the available water. Conversely, if the scheduled irrigation cycles for a day are providing more water than necessary as measured against a predetermined threshold, the system automatically adjusts the irrigation schedule by deleting the appropriate irrigation cycle(s) to achieve a desired level of water in the root zone. The present system achieves this by calculating the total daily water need for the particular plant species and then dividing up this amount between the initial start time and any additional subsequent cycle start times as determined by the system.

Furthermore, the present system may also provide for the flexibility to allow a user to designate certain days within an irrigation period as non-water or nonirrigation days. A user has the ability to select a day or a combination of days that the user does not want irrigation to occur. A preferred form of implementation is a matrix of on/off irrigation water day combinations. For example, if the user does not desire to irrigate on Saturdays, the user may select the irrigation schedule from the matrix that eliminates Saturday as a water or irrigation day. This flexibility, however, may be limited by the total daily water need of a particular plant species. In some cases, for instance, environmental factors may mandate irrigation seven days per week or each and every day of the irrigation period. Under these conditions, the present system will not allow a user to select any non-water or non-irrigation day. Using data such as available water, allowable depletion, root depth, the present system provides a checking mechanism to ensure that the user does not miscalculate the irrigation schedule thereby guarding against potential damage to the plant being irrigated.

Keeping the user's permissible designated non-water days in mind, the present system multiplies all of the cycle times by the number of cycles giving the total number of operating minutes of irrigation time for each valve under the control of the controller. The system then adds the total number of operating minutes for each valve together to determine the total length in time of all the valves for each day of the irrigation period. Once this total time for each day has been determined, the user will then have the ability to access the system to interrogate a matrix of on/off irrigation water day combinations to calculate the minimum irrigation time required for each irrigation day by shifting irrigation day schedules of each valve.

In addition to having the capability to allow a user to designate non-water days, the present system also allows the user to manually create and adjust his/her own desired irrigation schedule, subject to the water requirements of the plant. For instance, due to changes in weather conditions, it is sometimes desirable to deviate from the initial irrigation schedule. The user provides controller 105 with a scaling factor, typically less than one, but possibly greater than 1, to adjust the initial schedule. To simplify the discussion, the following explanation assumes an initial schedule of X=4, Y=6, and Z=10, or 240 minutes per week. The scaling factor is 0.5 or 50% of the initial schedule. The minimum number of cycles is X=3, and the minimum number of days for irrigation is 4. These minimums are functions of the soil, plant and irrigation conditions.

Without benefit of the present invention, a scaled schedule might be two ten-minute cycles six times per week, or four five-minute cycles six times per week, or four ten minute cycles three times per week. Each of these schedules is deficient.

According to the present invention, controller 105 may establish a schedule that includes three ten minute cycles four times a week for a total of 120 minutes. This schedule satisfies all the minimum conditions.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A method for establishing an irrigation schedule for a vegetation area over an irrigation period, comprising the steps of:
determining an appropriate irrigation cycle time and a number of irrigation cycles to be used for an irrigation day of the irrigation period; and thereafter
identifying one or more of said irrigation days during said irrigation period to maintain a quantity of water within a root zone of the vegetation area within a predetermined water profile.

2. A method for altering an irrigation schedule for a vegetation area over an irrigation period established for a particular environmental condition of the vegetation area, the irrigation schedule including a predetermined number of irrigation water days, a predetermined irrigation cycle time and a predetermined number of irrigation cycles to be used for an irrigation water day of the irrigation schedule, the method comprising the step of:
modifying a number of irrigation water days for the irrigation schedule based upon a modified environmental condition to maintain a quantity of water within a root zone of the vegetation area within a predetermined water profile.

3. The altering method of claim 2 wherein said modifying step comprises the step of adding additional irrigation water days when said quantity of water within said root zone falls below a pre-established first threshold value during the irrigation period.

4. The altering method of claim 2 wherein said modifying step comprises the step of adding additional irrigation water days when said quantity of water within said root zone is expected to fall below a pre-established first threshold value during the irrigation period.

5. The altering method of claim 2 wherein said modifying step comprises the step of deleting irrigation water days when said quantity of water within said root zone exceeds a pre-established first threshold value during the irrigation period.

6. The altering method of claim 2 wherein said modifying step comprises the step of deleting irrigation water days when said quantity of water within said root zone is expected to exceed a pre-established first threshold value during the irrigation period.

7. The altering method of claim 2 wherein said modifying step comprises the step of adjusting the number of irrigation water days when said quantity of water within said root zone either exceeds a pre-established first threshold value or falls below a pre-established second threshold value during the irrigation period.

8. The altering method of claim 2 wherein said modifying step comprises the step of adjusting the number of irrigation water days when said quantity of water within said root zone is expected to either exceed a pre-established first threshold value or fall below a pre-established second threshold value during the irrigation period.

9. A method for altering an irrigation schedule for a vegetation area over an irrigation period established for a particular environmental condition of the vegetation area, the irrigation schedule including a predetermined number of irrigation water days, a predetermined irrigation cycle time and a predetermined number of irrigation cycles to be used for an irrigation water day of the irrigation schedule, the method comprising the step of:
modifying the irrigation schedule based upon a modified environmental condition to maintain a quantity of water within a root zone of the vegetation area within a predetermined water profile.

10. The altering method of claim 9 wherein said modifying step comprises the step of adding additional irrigation cycles in an irrigation water day when said quantity of water within said root zone falls or is expected to fall below a preestablished first threshold value during the irrigation day.

11. The altering method of claim 9 wherein said modifying step comprises the step of deleting irrigation cycles in an irrigation water day when said quantity of water within said root zone exceeds or is expected to exceed a pre-established first threshold value during the irrigation day.

12. The altering method of claim 9 wherein said modifying step comprises the step of adjusting the number of irrigation cycles in an irrigation water when said quantity of water within said root zone either exceeds or is expected to exceed a preestablished first threshold value or falls or is expected to fall below a pre-established second threshold value during the irrigation day.

13. The altering method of claim 9 wherein said modifying step comprises the step of periodically adding additional irrigation cycles in an irrigation day when said quantity of water within said root zone falls or is expected to fall below a preestablished first threshold value during the irrigation day.

14. The altering method of claim 9 wherein said modifying step comprises the step of periodically deleting irrigation cycles in an irrigation day when said quantity of water within said root zone exceeds or is expected to exceed a pre-established first threshold value during the irrigation day.

15. The altering method of claim 11 further comprising the step of adding additional irrigation cycles in an irrigation day when said quantity of water within said root zone falls or is expected to fall below a pre-established second threshold value during the irrigation day such that said quantity of water exceeds a pre-established third threshold after addition of said irrigation cycles.

16. The altering method of claim 11 further comprising the step of deleting irrigation cycles in an irrigation day when said quantity of water within said root zone exceeds or is expected to exceed a pre-established first threshold value during the irrigation day such that said quantity of water exceeds a pre-established second threshold after deletion of said irrigation cycles.

17. The altering method of claim 2 wherein a user may identify one or more days as non-water days and wherein said modifying step will not add the non-water days to the irrigation schedule unless adding one or more non-water days will cause the said quantity of water within the said root zone to fall below a pre-established first threshold value during the irrigation period.

18. A method for altering an irrigation schedule for a plurality of vegetation areas over an irrigation period established for a particular environmental condition of the vegetation areas, the irrigation schedule including a predetermined irrigation cycle time and a predetermined number of irrigation cycles for each vegetation area to be used for an irrigation day of the irrigation schedule, the method comprising the step of:
modifying a number of irrigation days for the irrigation schedule of each of the plurality of vegetation areas based upon a modified environmental condition of each of the vegetation areas to maintain a quantity of water within a root zone of each of the vegetation areas within a predetermined water profile.

19. The altering method of claim 18 further comprising the step of reducing a total watering duration for each irrigation day of the irrigation period by moving irrigation days for each vegetation area from high total watering days to low total watering days while maintaining said quantity of water within said root zone of each of the vegetation areas within said predetermined water profile.

20. The altering method of claim 19 wherein a user may identify one or more days as non-water days and wherein said modifying step or said reducing step will not add the non-water days to the irrigation schedule.

21. An irrigation controller, comprising:
a valve, responsive to a control signal, for controlling water flow to a vegetation area;
a controller, coupled to said valve, for producing said control signal to operate said valve to irrigate said vegetation area according to an irrigation schedule over an irrigation period established for a particular environmental condition of said vegetation area, said irrigation schedule including a predetermined irrigation cycle time and a predetermined number of irrigation cycles to be used for an irrigation day of said irrigation schedule; and
an environmental condition change detector, coupled to said controller, for detecting a change in said particular environmental condition, such that said controller modifies a number of irrigation days for said irrigation schedule of said vegetation area based upon said change in said particular environmental condition to maintain a quantity of water within a root zone of said vegetation area within a predetermined water profile.

22. The irrigation controller of claim 21 wherein said environmental condition change detector includes a user operable interface to manually enter modified environmental condition parameters.

23. The irrigation controller of claim 21 wherein said environmental condition change detector includes a receiver for receipt of transmitted modified environmental condition parameters.

24. The irrigation controller of claim 21 wherein said environmental condition change detector includes a receiver for receipt of transmitted current environmental condition parameters and reports changes from the particular environmental condition.

25. The irrigation controller of claim 21 wherein said environmental condition change detector detects a change to evapotranspiration (ET).

26. The irrigation controller of claim 21 wherein said environmental condition change detector detects a change to a plant factor of the vegetation area.
